(19) United States
(12) Patent Application Publication
(10) Pub. No.: US 2023/0351203 A1
(43) Pub. Date: Nov. 2, 2023

(54) METHOD FOR KNOWLEDGE DISTILLATION AND MODEL GENERTATION

(71) Applicant: SAMSUNG ELECTRONICS CO., LTD., Suwon-si (KR)

(72) Inventor: Mete OZAY, Staines (GB)

(73) Assignee: SAMSUNG ELECTRONICS CO., LTD., Suwon-si (KR)

(21) Appl. No.: 18/218,405

(22) Filed: Jul. 5, 2023

Related U.S. Application Data
(63) Continuation of application No. PCT/KR2022/021496, filed on Dec. 28, 2022.

(30) Foreign Application Priority Data
Apr. 27, 2022 (GB) 2206105.5

(51) Int. Cl. G06N 3/096; G06N 3/045

(52) U.S. Cl. CPC G06N 3/096; G06N 3/045

(57) ABSTRACT

The present techniques generally relate to a system and method for knowledge distillation between machine learning, ML, models. In particular, the present application relates to a computer-implemented method for training a condenser model to learn how to transfer knowledge between a teacher model and a student model, and using this trained condenser model to more quickly generate new student models.

### CROSS-REFERENCE TO RELATED APPLICATION(S)

This application is a continuation application, claiming priority under § 365(c), of International Application No. PCT/KR2022/021496, filed on Dec. 28, 2022, which is based on and claims the benefit of United Kingdom Application No. 2206105.5, filed on Apr. 27, 2022 in the United Kingdom Intellectual Property Office, the disclosures of which are incorporated by reference herein in their entireties.

### BACKGROUND

### 1. Field

The present application generally relates to a system and method for knowledge distillation between machine learning, ML, models. In particular, the present application relates to a computer-implemented method for training a condenser model to learn how to transfer knowledge between a teacher model and a student model, and using this trained condenser model to more quickly generate new student models.

### 2. Description of Related Art

A number of methods for distilling knowledge from a pre-trained teacher model to a student model exist. However, they cannot be used for employing heterogenous neural networks, i.e. neural networks with different architectures and/or different types of ML models to learn how to distil knowledge from data. Typically, they cannot be used for multi-domain data, or for models used to perform multiple tasks such as object recognition and detection, or command and speech recognition.

Therefore, the present applicant has recognised the need for an improved technique for knowledge distillation.

### SUMMARY

According to an aspect of the disclosure, there is provided a system for knowledge distillation between machine learning, ML, models, the system comprising: a pre-trained teacher ML model, trained using a first training dataset, the pre-trained teacher ML model comprising first model parameters; a pre-trained student ML model, trained using a second training dataset, where the second training dataset is a subset of the first training dataset or is a different training dataset, the pre-trained student ML model comprising second model parameters; a condenser machine learning, ML, model parameterised by a set of parameters; and at least one processor coupled to memory configured to input, into the condenser ML model, a third training dataset, the third training dataset comprising the first model parameters, the second model parameters, the first training dataset and the second training dataset; and train the condenser ML model, using the third training dataset, to learn a parameter mapping function that models a relationship between the first model parameters and the second model parameters, and to output the second model parameters from an input comprising the first model parameters.

The condenser ML model may comprise a first submodel which is a parameter mapping model, and a second submodel which is a feature mapping model.

Training the condenser ML model may comprise training a first submodel of the condenser ML model, using: the first model parameters, which may comprise parameters of parameter mapping functions that map parameters of the pre-trained teacher ML model to parameters of the pre-trained student ML model; and the second model parameters, which may comprise parameters of parameter mapping functions that map parameters of the pre-trained student ML model to parameters of the pre-trained teacher ML model.

The parameter mapping functions may map comprises at least one of ML model weights, parameters or variables of graphical models, parameters of kernel machines, and variables of regression functions.

Training the condenser ML model may comprise training a second submodel of the condenser ML model, using: the first model parameters, which may comprise parameters of feature mapping functions that map features of the pre-trained teacher ML model to features of the pre-trained student ML model; and the second model parameters, which may comprise parameters of feature mapping functions that map features of the pre-trained student ML model to features of the pre-trained teacher ML model. The process to train the second submodel may not require accurately labelled data—it may use labelled and/or unlabelled data. This is advantageous as the training of the second submodel may be semi- or self-supervised.

More generally, the training of the condenser ML model may use labelled and/or unlabelled data, and may use zero-shot learning, few-shot learning, semi-supervised learning, or self-supervised learning methods.

The at least one processor may be further configured to generate a new student ML model using the pre-trained teacher ML model and the learned parameter mapping function. The new student ML model may be trained and enhanced incrementally, where performance may improve over time. The training dataset used to train the condenser model may comprise personal data items, which are personal to a user using the student model. Thus, the training dataset may comprise personal, private data of users.

In one example, the first training dataset may comprise images and/or videos, and the pre-trained teacher ML model may be trained to perform image processing or at least one computer vision task. In this case, the pre-trained teacher ML model may be trained to perform any one of the following computer vision tasks: object recognition, object detection, object tracking, scene analysis, pose estimation, image or video segmentation, image or video synthesis, and image or video enhancement.

In another example, the first training dataset may comprise audio files, and the pre-trained teacher ML model may be trained to perform audio analysis. In this case, the pre-trained teacher ML model may be trained to perform any one of the following audio analysis tasks: audio recognition, audio classification, speech synthesis, speech processing, speech enhancement, speech-to-text, and speech recognition.

According to an aspect of the disclosure, there is provided a system for knowledge distillation between machine learning, ML, models that perform object recognition, the system comprising: a pre-trained teacher ML model, trained using a first training dataset comprising a plurality of images of objects, the pre-trained teacher ML model comprising first model parameters; a pre-trained student ML model, trained using a second training dataset, where the second training dataset is a subset of the first training dataset or is a different training dataset, the pre-trained student ML model comprising second model parameters; a condenser machine learning, ML, model parameterised by a set of parameters; and at least one processor coupled to memory, for: inputting, into the condenser ML model, a third training dataset, the third training dataset comprising the first model parameters, the second model parameters, the first training dataset and the second training dataset; and training the condenser ML model, using the third training dataset, to learn a parameter mapping function that models a relationship between the first model parameters and the second model parameters, and to output the second model parameters from an input comprising the first model parameters.

In a third approach of the present techniques, there is provided a system for knowledge distillation between machine learning, ML, models that perform speech recognition, the system comprising: a pre-trained teacher ML model, trained using a first training dataset comprising a plurality of audio files, each audio file comprising speech, the pre-trained teacher ML model comprising first model parameters; a pre-trained student ML model, trained using a second training dataset, where the second training dataset is a subset of the first training dataset or is a different training dataset, the pre-trained student ML model comprising second model parameters; a condenser machine learning, ML, model parameterised by a set of parameters; and at least one processor coupled to memory configured to input, into the condenser ML model, a third training dataset, the third training dataset comprising the first model parameters, the second model parameters, the first training dataset and the second training dataset; and train the condenser ML model, using the third training dataset, to learn a parameter mapping function that models a relationship between the first model parameters and the second model parameters, and to output the second model parameters from an input comprising the first model parameters.

In a fourth approach of the present techniques, there is provided a computer-implemented method for knowledge distillation between machine learning, ML, models, the method comprising: obtaining a pre-trained teacher ML model, trained using a first training dataset, the pre-trained teacher ML model comprising first model parameters; obtaining a pre-trained student ML model, trained using a second training dataset, where the second training dataset is a subset of the first training dataset or is a different training dataset, the pre-trained student ML model comprising second model parameters; inputting, into a condenser ML model parameterised by a set of parameters, a third training dataset, the third training dataset comprising the first model parameters, the second model parameters, the first training dataset and the second training dataset; and training the condenser ML model, using the third training dataset, to learn a parameter mapping function that models a relationship between the first model parameters and the second model parameters, and to output the second model parameters from an input comprising the first model parameters.

The features described above in relation to the first approach apply equally to the second, third and fourth approach, and are therefore not repeated.

According to an aspect of the disclosure, there is provided a non-transitory data carrier carrying processor control code to implement the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The methods described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot, an edge device, or a mobile phone) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1 is a schematic diagram illustrating the concept of knowledge distillation;

FIG. 2 is a schematic diagram illustrating the knowledge distillation method of the present techniques;

FIG. 3 is a schematic diagram illustrating how the knowledge distillation method of the present techniques may be used to generate new student models;

FIG. 4 is a flowchart of example steps to perform knowledge distillation; and

FIG. 5 is a system for knowledge distillation.

### DETAILED DESCRIPTION

Broadly speaking, the present techniques generally relate to a system and method for knowledge distillation between machine learning, ML, models. In particular, the present application relates to a computer-implemented method for training a condenser model to learn how to transfer knowledge between a teacher model and a student model, and using this trained condenser model to more quickly generate new student models.

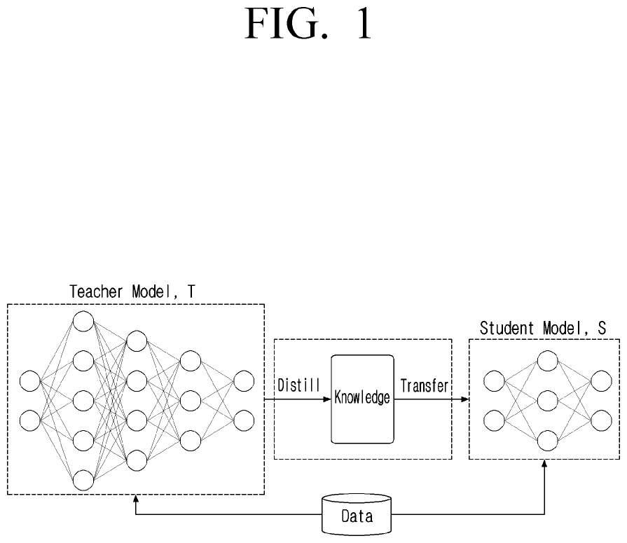

FIG. 1 is a schematic diagram illustrating the concept of knowledge distillation. Knowledge distillation is the process of transferring knowledge from a large model T (also known as a teacher model) to a smaller model S (also known as a student model). The teacher model may be a pre-trained neural network model.

Generally speaking, existing techniques for knowledge distillation propose using pre-defined loss functions of features F_{T} and F_{S} extracted from T and S, respectively, for knowledge distillation.

In contrast, the present techniques propose training a third machine learning model, also referred to herein as a condenser model. The condenser model is trained to learn how to distil knowledge among models T and S, and to produce or generate new models S′.

Thus, existing techniques neither use a trainable model to learn how to distil knowledge, nor use the knowledge to produce or generate new models. Instead, existing techniques merely target distilling ‘some knowledge’ from model T to model S.

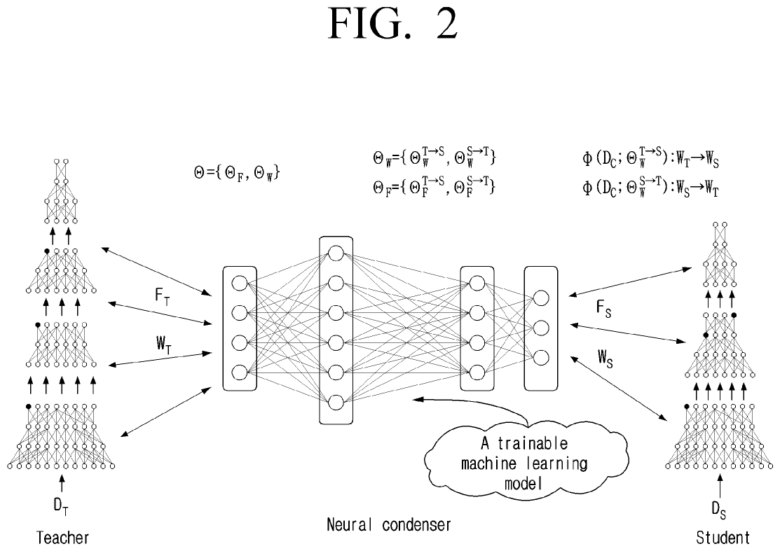

FIG. 2 is a schematic diagram illustrating the knowledge distillation method of the present techniques. The knowledge distillation method comprises using a condenser model (also known as a neural condenser) to aid the knowledge distillation between the teacher model and the student model. The present techniques comprise training a condenser machine learning model φ, that is parameterized by Θ, using model parameters of a teacher W_{T}. The condenser model is trained to learn how to generate parameters of a student W_{S}.

Generally speaking, a machine learning model is defined as a function f: X→Y that maps input elements x∈X to output y∈Y, and is parameterized by a set of parameters W. The input x∈X and an output y∈Y may be, for example, any of: a sensor output such as image, video, audio signal, text, meta-data (time stamp, location etc.), depth measurement; a supervised signal such as class label, pixel label, depth value; a parameter w∈W of a machine learning model, such as weight values of neural networks; an output of a neural network or a part of a neural network, such as features f∈F provided by neural networks, and a representation of hyper-parameters g∈G of a machine learning model, such as the graph structure of a neural network model presenting number of nodes, layers and connections among nodes at each layer, and operations implemented in layers.

A dataset is defined as a set of the tuples D={(xₙ, yₙ)}ₙ₌₁^{N}, where xₙ∈X and yₙ∈Y.

A machine learning model is trained to estimate a function f identified by the model by optimizing its parameters W minimizing a loss function l(D; W) on a dataset D using an optimization algorithm such as gradient descent and variations (e.g. stochastic gradient descent, Adam etc.), ADMM, projection based method, derivative-free optimization methods.

The present techniques involve three types of machine learning models: a teacher model, a student model, and a condenser model. Each of these models is described in turn below.

A teacher model is a machine learning model which can be implemented and realized by a deterministic or probabilistic machine learning algorithm or system such as the following machine learning algorithms used to identify the model:
Neural networks (e.g. convolutional neural networks (CNNs), LSTM/RNNs, RBMs, multi-layer perceptrons, transformers, auto-encoders, neural tangent machines, graph neural networks etc.),
probabilistic graphical models (e.g. MRFs, CRFs, HMMs),
kernel machines (e.g. support vector machines),
shallow machine learning algorithms such as regression functions etc.

A teacher model is parameterized by a set of parameters W_{T} such as weights of neural networks, parameters/variables of graphical models, parameters of kernel machines, and variables of regression functions. The parameters W_{T} of the teacher model are optimized by minimizing a loss function l(D_{T}; W_{T}) on a dataset D_{T}. The dataset D_{T} may contain suitable data items depending on the function or task being performed by the teacher model. For example, the first training dataset may comprise images and/or videos, and the pre-trained teacher ML model may be trained to perform image processing or at least one computer vision task. In this case, the pre-trained teacher ML model may be trained to perform any one of the following computer vision tasks: object recognition, object detection, object tracking, scene analysis, pose estimation, image or video segmentation, image or video synthesis, and image or video enhancement. In another example, the first training dataset may comprise audio files, and the pre-trained teacher ML model may be trained to perform audio analysis. In this case, the pre-trained teacher ML model may be trained to perform any one of the following audio analysis tasks: audio recognition, audio classification, speech synthesis, speech processing, speech enhancement, speech-to-text, and speech recognition.

A student model is a machine learning model which can be implemented and realized by a deterministic or probabilistic machine learning algorithm or system such as the following machine learning algorithms used to identify the model:
Neural networks (e.g. convolutional neural networks (CNNs), LSTM/RNNs, RBMs, multi-layer perceptrons, transformers, auto-encoders, neural tangent machines, graph neural networks etc.),
probabilistic graphical models (e.g. MRFs, CRFs, HMMs),
kernel machines (e.g. support vector machines),
shallow machine learning algorithms such as regression functions etc.

A student model is parameterized by a set of parameters W_{S} such as weights of neural networks, parameters/variables of graphical models, parameters of kernel machines, and variables of regression functions. The parameters W_{S} of the student model are optimized by minimizing a loss function l(D_{S}; W_{S}) on a dataset D_{S}. The dataset D_{S} may contain suitable data items depending on the function or task being performed by the student model. For example, the student model may perform the same function or task as the teacher model. Where the teacher model is able to perform multiple functions or tasks, the student model may perform one of these functions or tasks. Thus, the dataset D_{S} may be a subset of the teacher training dataset D_{T}, or may be a different training dataset.

A condenser or neural condenser is a machine learning model φ parameterized by a set of parameters Θ. The set of parameters Θ may itself contain another set of parameters Θ_{W} defined below. The set of parameters Θ may also contain a set of parameters Θ_{F} defined below, but Θ_{F} is not required.

Two types of parameters Θ_{W} and Θ_{F} are optimized by the neural condenser.

Firstly, the condenser optimizes parameter mapping parameters: Θ_{W}={Θ_{W}^{T→S}, Θ_{W}^{S→T}}. That is, the parameter mapping functions may map parameters of the pre-trained teacher ML model to parameters of the pre-trained student ML model as defined by φ(D_{C}; Θ_{W}^{T→S}):W_{T}→W_{S}, and may map parameters of the pre-trained student ML model to parameters of the pre-trained teacher ML model as defined by φ(D_{C}; Θ_{W}^{S→T}):W_{S}→W_{T}.

Secondly, the condenser optimises feature mapping parameters: Θ_{F}={Θ_{F}^{T→S}, Θ_{F}^{S→T}}. That is, the feature mapping functions may map features of the pre-trained teacher ML model to features of the pre-trained student ML model as defined by φ(D_{C}; Θ_{F}^{T→S}):F_{T}→F_{S}, and may map features of the pre-trained student ML model to features of the pre-trained teacher ML model as defined by φ(D_{C}; Θ_{F}^{S→T}):F_{S}→F_{T}.

Thus, the condenser is a machine learning model implementing a function model φ parameterized by a set of parameters Θ={Θ_{F}, Θ_{W}}. The function φ may be implemented using the following machine learning algorithms:
Neural networks: Shallow and deep neural networks (DNNs) such as multi-layer perceptrons (MLPs), convolutional neural networks (CNNs), RNNs/LSTMs, transformers, neural tangent kernels (NTKs), graph neural networks (GNNs), generative adversarial networks (GANs), energy based networks (EBNs) etc.
Kernel machines: Support vector machines (SVMs), multiple kernel learning (MKL) algorithms etc.
Probabilistic Graphical Models: Markov random fields (MRFs), Bayesian Networks (BNs), Conditional random fields (CRFs), etc.
Hyper-networks: Hyper-perceptrons, Graph Hypernet Networks (GHNs), etc.
Shallow machine learning algorithms: Regression algorithms (such as linear, non-linear regression, regression trees etc.), dimension reduction algorithms (such as PCA, ICA etc.), manifold learning algorithms (such as Isomap, LLMs etc.), clustering algorithms (such as k-means, hierarchical clustering etc.), ensemble learning algorithms (such as Boosting and variations (e.g. Adaboost, Xgboost etc.), Bagging, stacked generalization, decision trees etc.).

Training the condenser may comprise inputting a training dataset into the condenser. The parameters Θ are optimized by minimizing a loss function (D_{C}; Θ) using a dataset D_{C}. The training dataset of the neural condenser comprises dataset D_{C} which contains parameters of teacher and student models W_{T} and W_{S}, and may contain datasets of teacher and student models D_{T} and D_{S}. The dataset D_{C} may also contain features F_{T} and F_{S} extracted from datasets of teacher and student models D_{T} and D_{S} using parameters of teacher and student models W_{T} and W_{S}, respectively.

Training the neural condenser may comprise optimizing the parameters Θ of the neural condenser by minimizing a loss function l(D_{C}; Θ) using a dataset D_{C} with the optimization methods mentioned below. The teacher and student models are trained before training the neural condenser, and therefore may be called pre-trained teacher and student models, respectively.

During the training process, the pre-trained teacher model may be fixed or updated. If a pre-trained student model is available, the pre-trained student model may be updated (i.e. fine-tuned). If a pre-trained student model is not available, the pre-trained student model may be generated and trained from scratch as part of the training process for the condenser.

If only parameters of the teacher and student models are available, such that Θ={Θ_{W}}, then the neural condenser estimates parameters of φ(D_{C}; Θ_{W}^{T→S}) and φ(D_{C}; Θ_{W}^{S→T}) by minimizing a loss l(D_{C}; Θ). If the pre-trained teacher model is fixed, then the loss l(D_{C}; Θ) can be defined by l(D_{C}; Θ)=l_{W} (D_{C}; Θ) where

l_{W}(D_{C};Θ)≙l(D_{C};Θ_{W}^{T→S})+l(D_{C};Θ_{W}^{S→T})+l(D_{C};Θ_{W}^{T→S},Θ_{W}^{S→T})+l(D_{C},D_{S};W_{S})
where l(D_{C}; Θ_{W}^{T→S}) and l(D_{C}; Θ_{W}^{S→T}) are parameter embedding or transformation loss functions, and l(D_{C}; Θ_{W}^{T→S}, Θ_{W}^{S→T}) is a parameter correlation loss function, such as cross-covariance, or a linear/nonlinear kernel of Θ_{W}^{T→S}, Θ_{W}^{S→T} or their embedding.

If the pre-trained teacher model is not fixed, then its parameters W_{T} are also fine-tuned/updated. The loss l(D_{C}; Θ) can be defined by l(D_{C}; Θ)=l_{W} (D_{C}; Θ)+l(D_{C}, D_{S}; W_{T}) where l(D_{C}, D_{S}; W_{T}) is the loss function computed by employing W_{T} on D_{C} and D_{S}.

If both parameters and features of teacher and student models are available, such that Θ={Θ_{F}, Θ_{W}}, then the neural condenser estimates parameters of φ(D_{C}; Θ_{W}^{T→S}) and φ(D_{C}; Θ_{W}^{S→T}) by minimizing a loss l(D_{C}; Θ). If the pre-trained teacher model is fixed, the loss l(D_{C}; Θ) can be defined by

l(D_{C};Θ)=l_{W}(D_{C};Θ)+l_{F}(D_{C},D_{S};Θ)+l_{F}(F_{T},F_{S};Θ)

where

l_{F}(D_{C},D_{S};Θ)≙l(D_{C};Θ_{F}^{T→S})+l(D_{C};Θ_{F}^{S→T})+l(D_{C};Θ_{F}^{T→S},Θ_{F}^{S→T})+l(D_{C},D_{S};W_{S}),
l(D_{C}; Θ_{F}^{T→S}) and l(D_{C}; Θ_{F}^{S→T}) are feature embedding or transformation loss functions, l(D_{C}; Θ_{F}^{T→S}, Θ_{F}^{S→T}) is a parameter correlation loss function, such as cross-covariance, or a linear/nonlinear kernel of Θ_{F}^{T→S}, Θ_{F}^{S→T} or their embedding and l_{F}(F_{T}, F_{S}; Θ) is a feature correlation loss function, such as cross-covariance, or a linear/nonlinear kernel of features in F_{T}, F_{S}.

If the pre-trained teacher model is not fixed, then its parameters W_{T} are also fine-tuned/updated. In this case, the loss l(D_{C}; Θ) can be defined by

l(D_{C};Θ)=l_{W}(D_{C};Θ)+l_{F}(D_{C},D_{S};Θ)+l_{F}(F_{T},F_{S};Θ)+l(D_{C},D_{S};W_{T}).

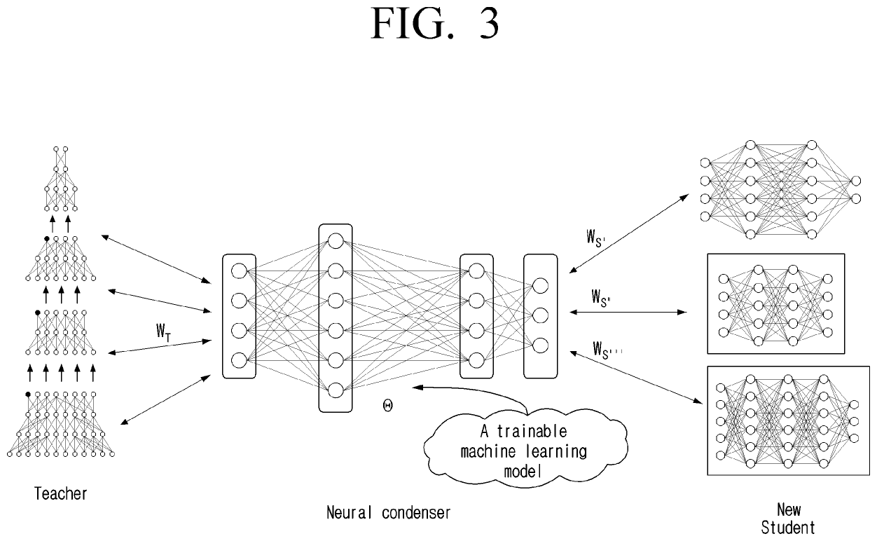

FIG. 3 is a schematic diagram illustrating how the knowledge distillation method of the present techniques may be used to generate new student models.

Once the training phase is completed, a function φ(Dₜₑₛₜ; Θ) is approximated by the optimized parameters Θ. Given a test dataset Dₜₑₛₜ, the function φ(Dₜₑₛₜ; Θ) can infer a student model Wₜₑₛₜ without additional training, or multiple student models {Wₜₑₛₜ^{m}}ₘ₌₁^{M} which can be aggregated by a transformation function to obtain Wₜₑₛₜ. The set Dₜₑₛₜ or another validation set Dᵥₐₗ can be used to fine-tune Wₜₑₛₜ.

It is possible to design the condenser model using neural architecture search methods using dataset D_{C}, and to identify the function φ using a neural network architecture. The function φ can be identified by a black box function drawn from a set of functions H, and an optimal function which minimizes the loss of the condenser can be searched on H using a black box search or optimization method such as Bayesian optimization algorithms, on D_{C}.

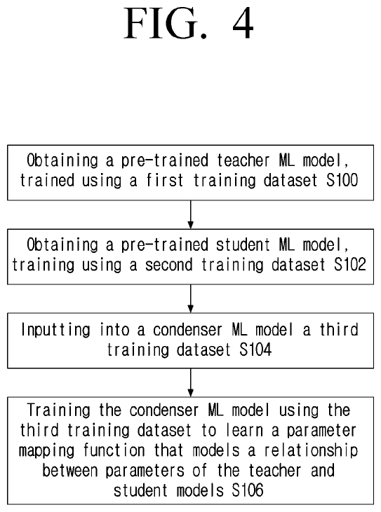

FIG. 4 is a flowchart of example steps to perform knowledge distillation between machine learning, ML, models. The method comprises: obtaining a pre-trained teacher ML model, trained using a first training dataset, the pre-trained teacher ML model comprising first model parameters (step S100); obtaining a pre-trained student ML model, trained using a second training dataset, where the second training dataset is a subset of the first training dataset or is a different training dataset, the pre-trained student ML model comprising second model parameters (step S102); inputting, into a condenser ML model parameterised by a set of parameters, a third training dataset, the third training dataset comprising the first model parameters, the second model parameters, the first training dataset and the second training dataset (step S104); and training the condenser ML model, using the third training dataset, to learn a parameter mapping function that models a relationship between the first model parameters and the second model parameters, and to output the second model parameters from an input comprising the first model parameters (step S106).

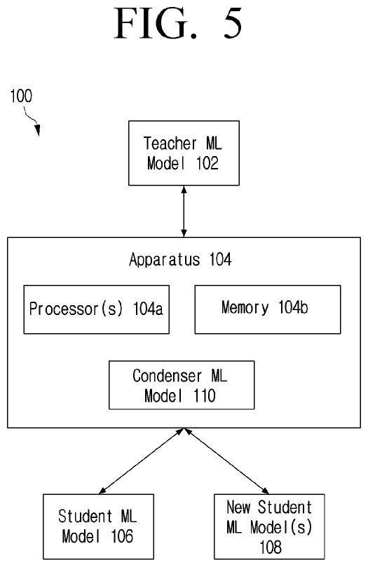

FIG. 5 is a system 100 for knowledge distillation between machine learning, ML, models. The system 100 comprises a pre-trained teacher ML model 102, trained using a first training dataset, the pre-trained teacher ML model 102 comprising first model parameters. The system 100 comprises a pre-trained student ML model 106, trained using a second training dataset, where the second training dataset is a subset of the first training dataset or is a different training dataset, the pre-trained student ML model comprising second model parameters.

The system 100 comprises a condenser machine learning, ML, model 110 parameterised by a set of parameters.

The system comprises an apparatus 104, which comprises at least one processor 104a coupled to memory 104b, for: inputting, into the condenser ML model 110, a third training dataset, the third training dataset comprising the first model parameters, the second model parameters, the first training dataset and the second training dataset, and training the condenser ML model 110, using the third training dataset, to learn a parameter mapping function that models a relationship between the first model parameters and the second model parameters, and to output the second model parameters from an input comprising the first model parameters. The apparatus 104 may be a server or a computer, for example.

The condenser ML model 110 may comprise a first submodel which is a parameter mapping model, and a second submodel which is a feature mapping model.

Training the condenser ML model 110 may comprise training a first submodel of the condenser ML model, using: the first model parameters, which may comprise parameters of parameter mapping functions that map parameters of the pre-trained teacher ML model to parameters of the pre-trained student ML model; and the second model parameters, which may comprise parameters of parameter mapping functions that map parameters of the pre-trained student ML model to parameters of the pre-trained teacher ML model.

The parameter mapping functions may map any one of the following parameters: ML model weights, parameters or variables of graphical models, parameters of kernel machines, and variables of regression functions.

Training the condenser ML model 110 may comprise training a first submodel of the condenser ML model, using: the first model parameters, which may comprise parameters of feature mapping functions that map features of the pre-trained teacher ML model to features of the pre-trained student ML model; and the second model parameters, which may comprise parameters of feature mapping functions that map features of the pre-trained student ML model to features of the pre-trained teacher ML model.

The at least one processor 104a may be further arranged to: generate a new student ML model 108 using the pre-trained teacher ML model 102 and the learned parameter mapping function.

In one example, the first training dataset may comprise images and/or videos, and the pre-trained teacher ML model may be trained to perform image processing or at least one computer vision task. In this case, the pre-trained teacher ML model may be trained to perform any one of the following computer vision tasks: object recognition, object detection, object tracking, scene analysis, pose estimation, image or video segmentation, image or video synthesis, and image or video enhancement.

In another example, the first training dataset may comprise audio files, and the pre-trained teacher ML model may be trained to perform audio analysis. In this case, the pre-trained teacher ML model may be trained to perform any one of the following audio analysis tasks: audio recognition, audio classification, speech synthesis, speech processing, speech enhancement, speech-to-text, and speech recognition.

The present techniques may be used in various AI systems, such as Bixby, Gallery, Camera, Display, Recommendation Systems etc. The present techniques may be deployed on any computing device. In some cases, only the student models that may be generated by the present techniques may be deployed on end-user devices, such as a smartphone, tablet, laptop, computer or computing device, virtual assistant device, a vehicle, a drone, an autonomous vehicle, a robot or robotic device, a robotic assistant, image capture system or device, an augmented reality system or device, a virtual reality system or device, a gaming system, an Internet of Things device, a smart consumer device, a smartwatch, a fitness tracker, and a wearable device. The present techniques may be deployed in any computing system, such as on-device computing systems, cloud, edge devices, internet of things, distributed systems, federated learning systems, human-computer interaction systems, cyber-physical systems, smart grid. It will be understood that these are non-exhaustive and non-limiting lists of example systems and devices.

The present techniques may be used for knowledge distillation between ML models performing any task or plurality of tasks. For example, the present techniques may be used for:
Computer Vision (for D>=1 dimensional and multi-/hyper-spectral Images and Videos): Object/person/face recognition/detection, semantic segmentation, object tracking, super-resolution, denoising, inpainting, depth estimation, pose estimation, computational photography, high dynamic range imaging, motion estimation, 2D/3D reconstruction, scene analysis, audio-visual video analysis, caption generation, image/video summarization, shadow detection/removal, OCR.
Speech Processing and Recognition: Speech enhancement/denoising/synthesis, speech recognition, speaker recognition/verification, text to speech, spoken language identification, audio classification, acoustic event detection, speech synthesis, noise-robust ASR, multilingual ASR, accent detection.
Natural Language Processing (NLP): Machine translation, language modeling, text generation, text recognition, question answering, document retrieval.
Recommendation Systems: Item and user recommendation, search systems.
Multi-modal (audio, video, text) joint tasks: Question Answering, Chatbot, Virtual Assistant, Image/Video to Text, Text to Image/Video, Audio-visual Speaker Recognition/Verification, Surveillance.
Medical Informatics and Neuroscience: Neuro-imaging, human-computer interaction, medical data analyses (images, sonar, video, text etc.), diagnoses.
Information Forensics and Security: Attack detection, intrusion detection, spam detection.
Robotics: Autonomous driving, humanoid robots, scene reconstruction, robot control.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A system for knowledge distillation between machine learning, ML, models, the system comprising:
a pre-trained teacher ML model, trained using a first training dataset, the pre-trained teacher ML model comprising first model parameters;
a pre-trained student ML model, trained using a second training dataset, where the second training dataset is a subset of the first training dataset or is a different training dataset, the pre-trained student ML model comprising second model parameters;
a condenser machine learning, ML, model parameterised by a set of parameters; and
at least one processor coupled to memory configured to:
input, into the condenser ML model, a third training dataset, the third training dataset comprising the first model parameters, the second model parameters, the first training dataset and the second training dataset; and
train the condenser ML model, using the third training dataset, to learn a parameter mapping function that models a relationship between the first model parameters and the second model parameters, and to output the second model parameters from an input comprising the first model parameters.

2. The system as claimed in claim 1 wherein training the condenser ML model comprises training a first submodel of the condenser ML model using:
the first model parameters, wherein the first model parameters comprise parameters of parameter mapping functions that map parameters of the pre-trained teacher ML model to parameters of the pre-trained student ML model; and
the second model parameters, wherein the second model parameters comprise parameters of parameter mapping functions that map parameters of the pre-trained student ML model to parameters of the pre-trained teacher ML model.

3. The system as claimed in claim 2 wherein the parameter mapping functions map comprises at least one of ML model weights, parameters or variables of graphical models, parameters of kernel machines, and variables of regression functions.

4. The system as claimed in claim 2 wherein training the condenser ML model comprises training a second submodel of the condenser ML model using:
the first model parameters, wherein the first model parameters comprise parameters of feature mapping functions that map features of the pre-trained teacher ML model to features of the pre-trained student ML model; and
the second model parameters, wherein the second model parameters comprise parameters of feature mapping functions that map features of the pre-trained student ML model to features of the pre-trained teacher ML model.

5. The system as claimed in claim 1 wherein the at least one processor is further configured to:
generate a new student ML model using the pre-trained teacher ML model and the learned parameter mapping function.

6. The system as claimed in claim 1 wherein the first training dataset comprises at least one of images and videos.

7. The system as claimed in claim 6 wherein the pre-trained teacher ML model is trained to perform a computer vision task,
wherein the computer vision task comprises at least one of object recognition, object detection, object tracking, scene analysis, pose estimation, image or video segmentation, image or video synthesis, and image or video enhancement.

8. The system as claimed in claim 1 wherein the first training dataset comprises audio files.

9. The system as claimed in claim 8 wherein the pre-trained teacher ML model is trained to perform audio analysis task,
wherein the audio analysis task comprises at least one of audio recognition, audio classification, speech synthesis, speech processing, speech enhancement, speech-to-text, and speech recognition.

10. A system for knowledge distillation between machine learning, ML, models that perform object recognition, the system comprising:
a pre-trained teacher ML model, trained using a first training dataset comprising a plurality of images of objects, the pre-trained teacher ML model comprising first model parameters;
a pre-trained student ML model, trained using a second training dataset, where the second training dataset is a subset of the first training dataset or is a different training dataset, the pre-trained student ML model comprising second model parameters;
a condenser machine learning, ML, model parameterised by a set of parameters; and
at least one processor coupled to memory configured to:
input, into the condenser ML model, a third training dataset, the third training dataset comprising the first model parameters, the second model parameters, the first training dataset and the second training dataset; and
train the condenser ML model, using the third training dataset, to learn a parameter mapping function that models a relationship between the first model parameters and the second model parameters, and to output the second model parameters from an input comprising the first model parameters.

11. A system for knowledge distillation between machine learning, ML, models that perform speech recognition, the system comprising:
a pre-trained teacher ML model, trained using a first training dataset comprising a plurality of audio files, each audio file comprising speech, the pre-trained teacher ML model comprising first model parameters;
a pre-trained student ML model, trained using a second training dataset, where the second training dataset is a subset of the first training dataset or is a different training dataset, the pre-trained student ML model comprising second model parameters;
a condenser machine learning, ML, model parameterised by a set of parameters; and
at least one processor coupled to memory configured to:
input, into the condenser ML model, a third training dataset, the third training dataset comprising the first model parameters, the second model parameters, the first training dataset and the second training dataset; and
train the condenser ML model, using the third training dataset, to learn a parameter mapping function that models a relationship between the first model parameters and the second model parameters, and to output the second model parameters from an input comprising the first model parameters.

12. A computer-implemented method for knowledge distillation between machine learning, ML, models, the method comprising:
obtaining a pre-trained teacher ML model, trained using a first training dataset, the pre-trained teacher ML model comprising first model parameters;
obtaining a pre-trained student ML model, trained using a second training dataset, where the second training dataset is a subset of the first training dataset or is a different training dataset, the pre-trained student ML model comprising second model parameters;
inputting, into a condenser ML model parameterised by a set of parameters, a third training dataset, the third training dataset comprising the first model parameters, the second model parameters, the first training dataset and the second training dataset; and
training the condenser ML model, using the third training dataset, to learn a parameter mapping function that models a relationship between the first model parameters and the second model parameters, and to output the second model parameters from an input comprising the first model parameters.

13. The method as claimed in claim 12 wherein training the condenser ML model comprises training a first submodel of the condenser ML model using:
the first model parameters, wherein the first model parameters comprise parameters of parameter mapping functions that map parameters of the pre-trained teacher ML model to parameters of the pre-trained student ML model; and
the second model parameters, wherein the second model parameters comprise parameters of parameter mapping functions that map parameters of the pre-trained student ML model to parameters of the pre-trained teacher ML model.

14. The method as claimed in claim 13 wherein the parameter mapping functions map comprises at least one of ML model weights, parameters or variables of graphical models, parameters of kernel machines, and variables of regression functions.

15. The method as claimed in claim 13 wherein training the condenser ML model comprises training a second submodel of the condenser ML model using:
the first model parameters, wherein the first model parameters comprise parameters of feature mapping functions that map features of the pre-trained teacher ML model to features of the pre-trained student ML model; and
the second model parameters, wherein the second model parameters comprise parameters of feature mapping functions that map features of the pre-trained student ML model to features of the pre-trained teacher ML model.
